(19) United States
(12) Patent Application Publication
(10) Pub. No.: US 2005/0144235 A1
(43) Pub. Date: Jun. 30, 2005

(54) Film transmission

(76) Inventor: Richard Bednall, Bournmouth (GB)

Correspondence Address: VENABLE LLP, P.O. BOX 34385, WASHINGTON, DC, 20435-9998, US

(21) Appl. No.: 10/491,606

(22) PCT Filed: Sep. 27, 2002
(86) PCT No.: PCT/GB02/04408

(30) Foreign Application Priority Data
Oct. 2, 2001 (GB) 0123564.7

(51) Int. Cl. G06F 15/16

(52) U.S. Cl. 709/206; 709/231

(57) ABSTRACT

The invention enables a short (typically 30s) advertising or other film to be multicast over the Internet. The film is embedded in the body of an electronic mail message for the network (rather than being sent as an attachment) so that the film runs as soon as the message is viewed; and the message may include means to send a reply automatically whenever the message is opened or forwarded, whereby transmission of the message may be tracked. The invention may be implemented by using proprietary computer systems and applications to (a) encode the film as a streaming file, (b) create a Web page and insert the file thereon with templates, (c) adapt the Web page for viewing as an electronic mail message and (d) prepare the message for transmission to selected recipients.

This Invention concerns the transmission of digitally recorded films over an electronic mail network, particularly but not necessarily exclusively the multicast transmission of films to selected recipients on the Internet.

The term “film” is used herein to refer to a recording on any medium from which a moving image, with or without sound, may by any means be produced.

Insofar as the invention makes use of proprietary computer stems and applications, it is hereby acknowledged that the following terms used herein are or may be trade marks, registered or unregistered: AY Mail, Dreamweaver, Frontpage, Java, Macromedia, Microsoft, Windows and Windows Media.

Advertising on the Internet is very exensice, but most of it is broadcast—that is to say, it is transmitted generally rather than being channelled to those who are interested in the subject of the advertisement. The shortcomings in this kind of advertising are well known: notably it is inefficient because the vast majority of people who see any given advertisement are not at all interested in the product advertised, and it is largely ineffective because the advertisement is inevitably framed for mass consumption rather than highlighting features which matter most to interested viewers.

Multicast advertising has been proposed to tackle these weaknesses of broadcast advertising. (In fact, multicasting is sometimes known as narrowcasting, to emphasise the difference). Multicast advertising Is directed specifically to people who are known (or, at least, believed) to be interested in the product advertised, with evident improvements in efficiency and effectiveness.

The Internet, and intranet and other systems organised on similar principles, allow advertising to be very closely targeted, right down to a single individual, which is ideal for multicasting. Nevertheless Internet advertising, remains very primitive, being almost entirely confined to banner advertisements with minimal movement and no sound. Such advertisements lack impact, and it is hardly surprising that television continues to attract far more advertising revenue. But this is changing.

It is well known that television-style films may be transmitted over the Internet. Microsoft Corporation developed Audio Video Interleave (AVI) for playback of audio and video from hard disks and CD-ROMs on personal computers, and more recently defined Advanced Streaming Format (ASP) which among other things includes synchronising time stamps to facilitate real time or streaming audio and video playback over the Internet.

From the foregoing discussion it will be understood that the Internet supports both multicasting (through electronic mail) and film (through AVI).

There is, further, provision for these two things to be combined, through Multipurpose Internet Mail Extensions (MIME), which allows AVI files and other multimedia data types to be attached to an electronic mall message. Hence a film in AVI format may be sent to one or more selected recipients as an attachment to an electronic mall message.

For advertising purposes, the drawback in this is that the advertisement is an attachment, and it will not be seen unless and until the recipient opens the attachment. It is an object of the present invention to enable a film (for advertising or any other purpose) to be associated with an electronic mail message in such a way that it runs as soon as the message is viewed.

Thus according to the invention there is provided a method of transmitting a digitally recorded film by means of an electronic mail network wherein the film is embedded in the body of an electronic mail message for the network so that the film runs as soon as the message is viewed.

The message may include means, such as instructions coded in Hyper Text Markup Language (html), to send a reply automatically whenever the message is opened or forwarded, whereby transmission of the message may be tracked.

The invention is particularly applicable to the transmission of advertising or other films over the Internet or a part thereof (such as the World Wide Web or an Intranet) and to this end the method may include the steps of—
(a) encoding the film as a streaming file;
(b) creating a Web page and inserting therein templates and said file;
(c) adapting the Web page for viewing as an electronic mall message; and
(d) preparing the message for transmission to a selected recipient on the network.

The film may be in AVI and the streaming file in ASF. To facilitate transmission among different systems connected to the network, the streaming file may be encoded using a specific encoder with a specific setting.

The Web page is preferably created using a frame-based approach so that the position of the message may be controlled. The Web page may be adapted by means of electronic mail sending software arranged, possibly by modification of its instructions, to embed the message rater than carry it as an attachment.

The message may of course be sent to a plurality of selected recipients and is preferably prepared for transmission by inserting the electronic mail address of the or each recipient and adding in corresponding routing and sending information.

The invention will now be described with reference to specific examples of the steps in the method which make use of proprietary systems and applications.

A film for transmission by the method is typically a 30 second advertising film containing bot audio and video, recorded (and edited etc) in AVI format. Those skilled in the science will appreciate that AVI allows an Internet user to download an audio-video file from a remote site for playback from a hard drive of the user's computer. It is widely known that AVI is not well suited to real-time or streaming playback over the Internet or other packet-switched networks because it lacks means to synchronise (and resynchronise) the audio and video teams to be downloaded from and then encoded as an ASF streaming tile. However an AVI file may be converted to ASF, which does support audio-video streaming over the Internet. Thus the first step in transmitting the film by means of the invention is to convert it from AVI to ASF.

(a) Encoding

The conversion process makes use of Windows Media (Version 4.1.0), which is a suite of digital multimedia applications marketed by Microsoft.
1. Open the Encoder.
2. Choose Custom Settings. Select AVI. Select the filename of the AVI file to be encoded.
3. Use single bit rate video.
4. choose the bit rate 80-100 kbps
5. Choose codecs as follows—
Audio: MPEG layer 3 16 kbps 11, 025 khz Mono
Video: Microsoft MPEG-4 Video codec V1
6. Clock Advanced tab. Choose required size and set slider to 50.
7. Set Delay Buffer to 1.
8. Choose location for the ASF file and name it.
9. Click Finish.

Next, a Web page is created. This is done using a frame based approach so as to control the positioning of the message to be transmitted in the window. The process provides three button options (with rollover options) namely Visit the Website, E-mail Us and Call You Back. The web page is coded in HTML and specially coded Java and at this stage a tracking code is inserted.

(b) Creating a Web Page

The Web page is created by means of Dreamweaver 1, which is a WYSIWYG web site building application marked by Macromedia.
1 Create a folder for the message to be transmitted and insert the ASF file and a selected graphic template (default size 450×320).
2 Open Dreamweaver 1.
3 Save the file as vsmall.htm.
4 Inset the graphic template (using Insert-image).
5 Select the Draw Layer tool from the Objects toolbar.
6 Draw a layer where the message is required to appear on the template.
7 In the coding, ensure that the code for the layer is after the code for the template (moving one or both if necessary).
8 Add in buttons for weblinks (Visit the Website), emaillinks (E-mail Us) and callback (Call You Back).
9 Add a tracking code.
10 Add a source lock code.
11 Save the HTM document and Close.

Once the template is complete, the ASF video file can be added in to the appropriate frame. Two separate programs are used in the process. The second one inserts coding which enables the video to begin automatically on accessing the email.

(c) Adapting the Web Page

The Web page is adapted for viewing by means of Frontpage 2000, which is a Web authoring application marketed by Microsoft
1 Open Frontpage 2000.
2 Open the HTM document.
3 Click on the Layer area.
4 Click on the Insert and then the Picture tab.
5 Select the Video option,
6 Choose, the ASF file, which causes an Object to appear in the top left corner of the Layer. Click and drag this Object until it fills the Layer area.
7 Adjust the Object by clicking the HTM tab and amending the values for height and width to those of the ASF file (default 320×160).
8 Click the Preview tab to check that the movie runs satisfactorily and that is property aligned. Adjust HML settings as appropriate.
9 Save the HTM document
10 Click on the HTM tab. Select all the HTML code. Press CTRL C.
11 Close Frontpage 2000.

The HTM page is now transferred to specific email sending software. Here it is adapted so that the graphics and video files are not carded as attachments but embedded within the email itself. This is achieved by adding in a cid: prefix within the application code.

The message is prepared for transmission to the selected recipients by Inserting their group of electronic, mail addresses and adding in corresponding routing and sending information. At this stage the embedded files are programmed into the software for onwards transmission.

(d) Preparing Transmission

The message is prepared for transmission by means of an electronic mail sending application known as AY Mail.
1 Open AY Mail V1.7.
2 Crick on the Message tab.
3 Press CTRL V to reveal the application code.
4 For every graphic (templates; buttons, gifs etc) change the code as follows—
Change_src=“Background1.jpg” . . . to _src=cid:Background1.jpg . . .
Change_dynsrc=“vismail.asf” . . . to _dynsrc=cid:vismail.asf . . .
   5 Click on the Recipients tag and insert electronic mail addresses for the or each intended recipient of the message. (This may be done by cut and paste from any text file).
   6 Click on the Header and then—
      In the To field put Recipients
      In the From field put the sender's electronic mail address
      In the Subject field put Vismail.
   7 Click Attachments. Attach all the graphics files and the ASF file that comprise the message, but excluding the HTM document
   8 Click on the Options tab and put in the sender's Simple Mail Transfer Protocol (SMTP) address

The message is now ready to be sent. Because the film is embedded therein it will be seen as soon as the message is viewed by a recipient.

Whist the invention has been described with reference to the use of particular proprietary computer systems and applications, it will be understood that the invention may be implemented in other ways, and other modifications and adaptations will be apparent to those skilled in the science.

1-11. (canceled)

12. A method for transmitting electronic messages over a network comprising:
embedding an electronic mail message with a film;
transmitting the electronic mail message for viewing, and
running the film as soon as the electronic mail message is viewed.

13. The method of claim 12 further comprising:
transmitting an automatic reply message when the electronic mail message is activated, opened or forwarded; and
tracking the transmission of the electronic mail message.

14. The method of claim 13, wherein the automatic reply message comprises a coded instruction.

15. The method of claim 14, wherein the coded instruction comprises a HTML coded instruction.

16. The method of claim 12, wherein the network comprises at least one of the Internet or a part thereof.

17. The method of claim 12 further comprising:
converting the film to a streaming file;
creating a Web page;
inserting a templates and the streaming file in the Web page;
adapting the Web page for viewing as an electronic mail message; and
transmitting the electronic mail message to a selected recipient on the network.

18. The method of claim 17, wherein the film is converted from an AVI format to an ASF format.

19. The method of claim 17, wherein the streaming file is encoded using an encoder that allows for transmission of the electronic mail message among different systems connected to the network.

20. The method of claims 17, wherein the Web page is created using a frame-based approach to control the position of the electronic mail message.

21. The method of claim 17 further comprises adapting the Web page using an electronic mail sending software that is arranged to embed the film in the electronic mail message.

22. The method of claim 21, wherein the film is embedded in the electronic mail message by modifying at least one instruction of the electronic mail sending application.

23. The method of claim 17, further comprising inserting an electronic mail address of the recipient and corresponding routing and sending information.

24. An electronic mail transmission system, comprising:
an electronic mail network that delivers an electronic mail message to a recipient;
a recipient computer used for viewing the electronic mail message, wherein the electronic mail message has an embedded film that runs as soon as the electronic mail message is viewed.

25. The system of claim 24, wherein the electronic mail message is adapted to send an automatic reply when activated, opened or forwarded.

26. The system of claim 24, wherein the electronic mail message comprises a Web page adapted for viewing as an electronic mail message.

27. The system of claim 26, wherein the film is encoded as a streaming file.

28. The system of claim 27, wherein the streaming file comprises a file converted from an AVI format to a ASF format.

29. The system of claim 27, wherein the film is a digitally recorded film.
